(19) United States
(12) Patent Application Publication
(10) Pub. No.: US 2014/0036087 A1
(43) Pub. Date: Feb. 6, 2014

(54) ENHANCING A USER EXPERIENCE UTILIZING CAMERA LOCATION INFORMATION AND USER DEVICE INFORMATION

(71) Applicants: Nobuki Furue, San Diego, CA (US); Naoto Shimizu, San Diego, CA (US); Takayuki Kitahara, San Diego, CA (US)

(72) Inventors: Nobuki Furue, San Diego, CA (US); Naoto Shimizu, San Diego, CA (US); Takayuki Kitahara, San Diego, CA (US)

(73) Assignee: SONY CORPORATION, Tokyo (JP)

(21) Appl. No.: 13/563,578

(22) Filed: Jul. 31, 2012

(51) Int. Cl. H04N 7/18

(52) U.S. Cl. 348/157; 348/E07.085

(57) ABSTRACT

A user experience includes an imaging service package provided at a snow park that is able to acquire videos and images of users of the snow park. Cameras are pre-installed in many places to take footage of the users. The cameras are able to shoot a moment of a snowboarder's jump from underneath, above, or moving along with the boarder. Each camera records, transmits and keeps a stream on a server, where the footage is stored. Users are able to easily access the footage anytime using their smart phones and share the footage. The system identifies a user and his footage by matching camera location data and user data (e.g., using NFC, a mid-range communication implementation, GPS data and/or timestamps in the smart phone or other computing devices). The users are able to easily obtain their footage and share the footage through the smart phone without any other devices.

### FIELD OF THE INVENTION

The present invention relates to the field of imaging service packages. More specifically, the present invention relates to imaging service packages at sports and other activity locations.

### BACKGROUND OF THE INVENTION

Many ski and snowboard parks have simple web cams which show the current conditions on the mountain. However, they are typically stationary and too far away from the activity on the mountain to capture exciting videos.

When events are held in the ski and snowboard parks, professional cameras are set up to capture the action and transmit the video to viewers on the Internet or television. However, the professional cameras are controlled by the presenter of the event and are only used during the event.

Amusement parks employ cameras positioned to take pictures of roller coaster users. Then, the users must wait in line and search for their photos after the ride has ended. The experience is inconvenient and time consuming.

With improved mobile video capturing devices such as smart phones with embedded cameras capable of taking video, individual users are able to acquire videos and post the videos online at sites such as Youtube™ or Facebook®. However, users would prefer to spend time focusing on their activity as opposed to attempting to be professional videographers.

Thus, the experience of snow sports and other activities could be enhanced.

### SUMMARY OF THE INVENTION

A user experience includes an imaging service package provided at a snow park that is able to acquire videos and images of users of the snow park. Cameras are pre-installed in many places to take footage of the users. The cameras are able to shoot a moment of a snow boarder's jump from underneath, above, or moving along with the boarder. Each camera records, transmits and keeps a stream on a server, where the footage is stored. Users are able to easily access the footage anytime using their smart phones and share the footage. The system identifies a user and his footage by matching camera location data and user data (e.g., using NFC, a mid-range communication implementation, GPS data and/or timestamps in the smart phone or other computing devices). The users are able to easily obtain their footage and share the footage through the smart phone without any other devices.

In one aspect, a method of providing an enhanced user experience programmed in a non-transitory memory of a device comprises receiving acquired content and transmitting the acquired content to a user device by matching the acquired content with the user device. The user experience is at a snow park, a skateboarding park, a BMX bike park, an amusement park, a racecar driving track or on a rafting trip in a river. The acquired content comprises a video and/or an image. The acquired content is acquired by a plurality of cameras positioned at a snow park to capture a user's experience from different angles and locations. The plurality of cameras includes at least one of a cable camera system with a balloon, a height adjustable hanging camera and a fixed mount camera. The acquired content is matched with the user device using location information of a camera and user information. The user information comprises GPS information of the user device and timestamp information of the user device. The user information comprises Near Field Communication information. The user information comprises mid-range communication information. The Near Field Communication information is stored in a lift ticket. The Near Field Communication information is stored in an article of clothing or equipment. The acquired content transmitted to the user device is a low resolution content, and a corresponding high resolution content is available for purchase. The method further comprises sharing the acquired content with additional users by posting the content to a webpage or sending the content to phones of the additional users. The acquired content is displayed on the user device with a user-specific background. The method further comprises presenting an advertisement on the user device using metadata contained in a user's Near Field Communication card or smart phone. The user device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a method of receiving an enhanced user experience programmed in a non-transitory memory of a device comprises selecting content to receive and receiving the content from a server wherein the content is matched to the user device using camera location information and user device information. The user device information comprises one or more of GPS information, timestamp information, Near Field Communication information and mid-range communication information. The user experience is at a snow park, a skateboarding park, a BMX bike park, an amusement park, a racecar driving track or on a rafting trip in a river. The content comprises a video and/or an image. The content is acquired by a plurality of cameras positioned at a snow park to capture a user's experience from different angles and locations. The plurality of cameras includes at least one of a cable camera system with a balloon, a height adjustable hanging camera and a fixed mount camera. The content received is a low resolution content, and a corresponding high resolution content is available for purchase. The method further comprises sharing the content with additional users by posting the content to a webpage or sending the content to phones of the additional users. The method further comprises presenting an advertisement on the user device using metadata contained in a user's Near Field Communication card or smart phone. The device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a network of devices for providing an enhanced user experience comprises one or more cameras for acquiring content and a server for receiving the content and transmitting the content to a user device by matching the content with the user device using camera location information and user device information. The user device information comprises one or more of GPS information, timestamp information, Near Field Communication information and mid-range communication information. The user experience is at a snow park, a skateboarding park, a BMX bike park, an amusement park, a racecar driving track or on a rafting trip in a river. The content comprises a video and/or an image. The one or more cameras are positioned at a snow park. The content received is a low resolution content, and a corresponding high resolution content is available for purchase. The server is further for sharing the content with additional users. The one or more cameras include at least one of a cable camera system with a balloon, a height adjustable hanging camera and a fixed mount camera.

In another aspect, a device comprises a memory for storing an application, the application for: tracking locations of the device over a period of time, communicating the locations of the device with a server and receiving content from the server, wherein the content is matched to the device using camera location information, the locations of the device and timestamp information and a processing component coupled to the memory, the processing component configured for processing the application. The content comprises a video and/or an image. The content is acquired by a plurality of cameras positioned at a snow park to capture a user's experience from different angles and locations. The plurality of cameras includes at least one of a cable camera system with a balloon, a height adjustable hanging camera and a fixed mount camera. The content is a low resolution content, and a corresponding high resolution content is available for purchase. The application is further for sharing the content with additional users by posting the content to a webpage or sending the content to phones of the additional users. The application displays the content on the device with a user-specific background. The application is further for presenting an advertisement on the device using metadata contained in a user's Near Field Communication card or smart phone.

In yet another aspect, a server device comprises a memory for storing an application, the application for receiving content acquired by a plurality of cameras including camera location information, receiving user device information from a tracked user device and transmitting the content to the tracked user device by matching the acquired content with the tracked user device using the camera location information and the user device information and a processing component coupled to the memory, the processing component configured for processing the application. The user device information comprises one or more of GPS information, timestamp information, Near Field Communication information and mid-range communication information. The acquired content comprises a video and/or an image. The plurality of cameras are positioned at the snow park to capture a user's experience from different angles and locations. The content transmitted to the user device are low resolution content, and corresponding high resolution content are available for purchase. The application is further for sharing the content with additional users by posting the content to a webpage or sending the content to phones of the additional users. The plurality of cameras includes at least one of a cable camera system with a balloon, a height adjustable hanging camera and a fixed mount camera.

### BRIEF DESCRIPTION OF THE DRAWINGS

FIG. 1 illustrates an exemplary configuration of cameras positioned to acquire video and images according to some embodiments.

FIG. 2 illustrates an exemplary configuration of a camera positioned to acquire video and images according to some embodiments.

FIG. 3 illustrates an exemplary image acquired by a camera from above according to some embodiments.

FIG. 4 illustrates an exemplary image acquired by a camera from a ground level according to some embodiments.

FIG. 5 illustrates a system for acquiring video and providing the video to users according to some embodiments.

FIG. 6 illustrates exemplary streaming videos according to some embodiments.

FIG. 7 illustrates a mobile device receiving selected clips from video streams according to some embodiments.

FIG. 8 illustrates a flowchart of a method of capturing videos and providing the videos to users according to some embodiments.

FIG. 9 illustrates a block diagram of an exemplary computing device configured to implement the sports experience method according to some embodiments.

FIG. 10 illustrates an exemplary image of cable cameras coupled to wires coupled to balloons acquiring video and/or images of a snowboarder on a halfpipe according to some embodiments.

FIG. 11 illustrates an exemplary image of cable cameras coupled to wires coupled to balloons acquiring video and/or images of a snowboarder on a run with jumps according to some embodiments.

FIG. 12 illustrates an exemplary system recording video and/or images using several different types of cameras, uploading the video streams to a server which matches the video and/or images to a user or a user's device according to some embodiments.

FIG. 13 illustrates a mobile device app with background colors reflecting each user's videos according to some embodiments.

FIG. 14 illustrates a website with background colors reflecting each user's videos according to some embodiments.

FIG. 15 illustrates an exemplary screenshot of browsers with content displayed related to the enhanced user experience according to some embodiments.

FIG. 16 illustrates an exemplary screenshot of mobile devices with content displayed related to the enhanced user experience according to some embodiments.

FIG. 17 illustrates a lift ticket capable of implementing NFC or another communication implementation to match users with their videos and/or images according to some embodiments.

FIG. 18 illustrates a jacket containing an embedded NFC chip or another communication device to match users with their videos and/or images according to some embodiments.

FIG. 19 illustrates three different types of cameras for enhancing a user experience and images acquired by the cameras according to some embodiments.

FIG. 20 illustrates a perspective view of a cable camera system with balloons according to some embodiments.

FIG. 21 illustrates dimensions of the cable camera system with balloons according to some embodiments.

FIG. 22 illustrates a closeup view of the cable camera system according to some embodiments.

FIG. 23 illustrates components of a cable camera system according to some embodiments.

FIG. 24 illustrates a perspective view of a height adjustable hanging camera according to some embodiments.

FIG. 25 illustrates dimensions of the height adjustable hanging camera according to some embodiments.

FIG. 26 illustrates a closeup view of the height adjustable hanging camera according to some embodiments.

FIG. 27 illustrates components of the height adjustable hanging camera according to some embodiments.

FIG. 28 illustrates a perspective view of fixed mount cameras according to some embodiments.

FIG. 29 illustrates dimensions of the fixed mount cameras according to some embodiments.

FIG. 30 illustrates a closeup view of a fixed mount camera according to some embodiments.

FIG. 31 illustrates components of a fixed mount camera according to some embodiments.

FIG. 32 illustrates a view of a total system for enhancing a user experience according to some embodiments.

### DETAILED DESCRIPTION OF THE PREFERRED EMBODIMENT

An imaging service package is provided at a snow park. Professional quality cameras are pre-installed in many places to take footage of visitors. The cameras are able to shoot a moment of a snow boarder's jump from underneath, above, moving along with the boarder and/or any other angle. Each camera records for a day or another period of time, transmits the footage and keeps a stream on server, where the footage is recorded. Users are able to easily access the footage anytime using their smart phones or another device and share the footage.

The system identifies a user and his footage by matching camera location data, Global Positioning System (GPS) data, timestamps, short range communication information (e.g, Near Field Communication (NFC)), medium range communication information, and/or any other information in the smart phone and/or another device. In some embodiments, other or additional information is utilized to match the user and the video. In some embodiments, a mobile device signature or other identifier is communicated to one or more of the cameras, and the mobile device signature is embedded with the video. For example, as the user passes by a first camera, the mobile device communicates a unique signature, and then for retrieval of the video, the unique signature within the video is matched with the mobile device. The users are able to easily obtain their professional quality footage and share the footage through the smart phone without any other devices.

In some embodiments, an application (“app”) for the smart phone and a low resolution version of a video are provided for free, and a higher resolution video and rights to the video are available for a fee. In some embodiments, the user initiates the app to begin tracking GPS, timestamp, NFC, mid-range communication and/or any other communication information. The snow park owner is able to be charged to use the system.

In some embodiments, the system is able to stream footage to televisions and other devices in restaurants, outdoor big screens, websites and/or any other location. Although the imaging service package uses an example of a snow park, the imaging service package is able to be used anywhere, for example, at a skateboarding park, a BMX bike park, an amusement park, a racecar driving track or on a rafting trip in a river.

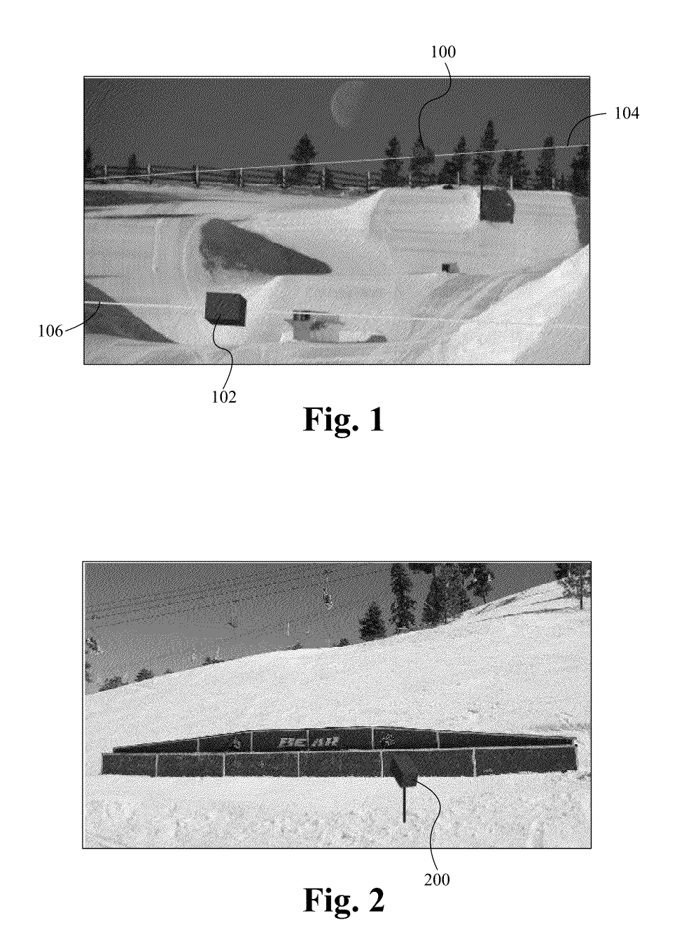

FIG. 1 illustrates an exemplary configuration of cameras positioned to acquire video and images according to some embodiments. A first camera 100 is positioned on a cable 104 high above the snow park to capture video from above. A second camera 102 is positioned on a lower cable 106 to capture video from a ground view of the snow park action. Additional cameras are able to be positioned in other locations to capture any angle desired. In some embodiments, the cameras are movable. For example, the cameras are able to detect where the action is (e.g., a snowborder) and using an internal motor that enables the camera to travel along a cable, the camera is able to move to a new position. In some embodiments, the cameras are positioned using balloons or another temporary floatation device to easily and quickly position the cameras. In some embodiments, the cameras are coupled to a cable which are coupled to balloons. In some embodiments, the cameras are height adjustable hanging cameras. In some embodiments, the cameras are fixed mount type cameras.

FIG. 2 illustrates an exemplary configuration of a camera positioned to acquire video and images according to some embodiments. A stationary camera 200 is positioned to capture a view from below a snow boarder or skier as they traverse a rail. In some embodiments, cameras are positioned in trees, in, next to or at the bottom of a mogul, a jump, a rail and/or any other obstacle. In some embodiments, the cameras are positioned using quick-release mechanisms to enable quick positioning and removal of the cameras.

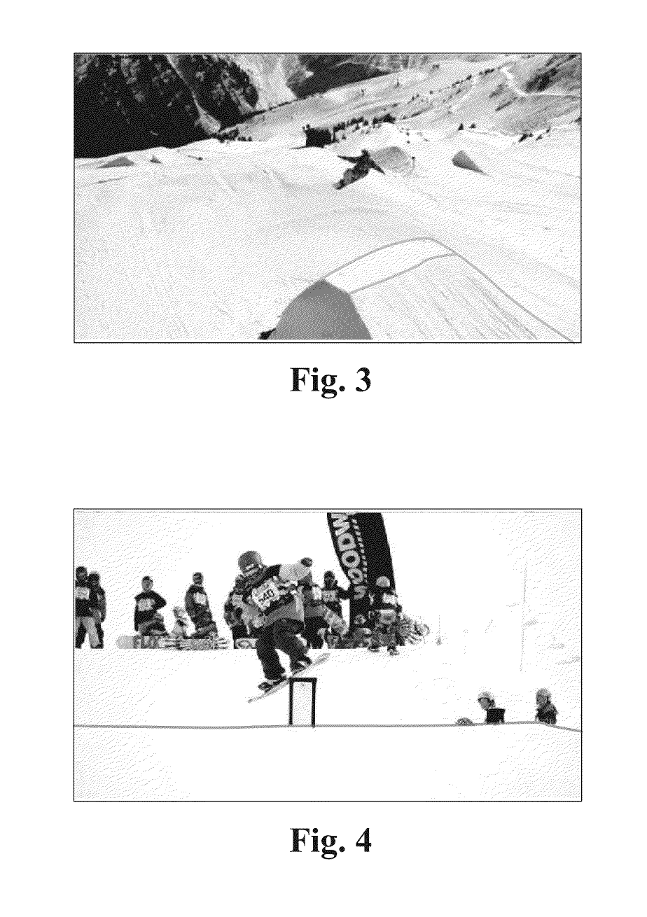

FIG. 3 illustrates an exemplary image acquired by a camera from above according to some embodiments. For example, the exemplary image is acquired by the camera 100 positioned above the snow park. FIG. 4 illustrates an exemplary image acquired by a camera from a ground level according to some embodiments. For example, the exemplary image is acquired by the camera 102 positioned at the ground level.

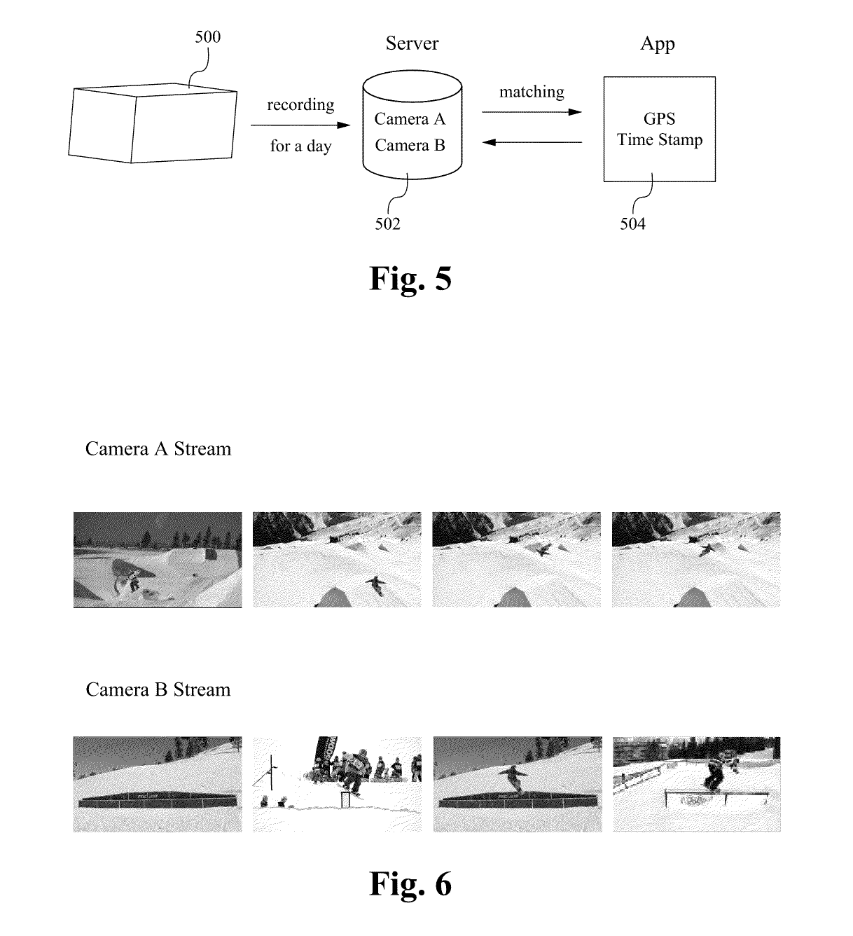

FIG. 5 illustrates a system for acquiring video and providing the video to users according to some embodiments. A camera 500 records videos and images of a subject (e.g. a snowboarder). Additional cameras record videos as well. The cameras are able to be positioned to acquire many different angles of action and locations such as from below the subject, above the subject, in front of the subject, behind the subject, moving with the subject, and/or any other angle. The cameras upload the videos to a server 502. The uploading is able to be implemented in any manner. For example, the videos are uploaded at specified intervals. In another example, the videos are uploaded continuously. The server 502 stores the uploaded videos. The server 502 locates a match of a user device 504 and transmits the matching videos to the user device 504. In some embodiments, the server 502 presents thumbnails, clips and/or any other representation of the videos to the user device 504, from which the user is able to select videos for download. The user device 504 is matched to the videos using camera location data and user data (e.g., GPS data, NFC data, mid-range communication data, timestamps and/or any other information). For example, a smart phone carried by a user tracks a user's GPS data and included with the GPS data are timestamps of when the user was at specific locations. The cameras positioned in the snow park are able to provide location information (e.g. embedded in the videos or images). Then, the GPS and time information from the smart phone is compared with the camera location information in the videos, and when the time and location of the smart phone matches (e.g., is the same as or is similar to) the video location information, the system recognizes a user match with the video. The GPS information and timestamp information of the smart phone are able to be recorded with or without a user initiating a specific app. In another example, an NFC chip is embedded in or on a lift ticket, smart phone or another object on or carried by the user. In some embodiments, the user taps the NFC-enabled device to a receiver to register the user's identification, and then the system is able to match the identification to the video and/or images. In some embodiments, the user taps the NFC-enabled device before each jump or other move to trigger a communication. In some embodiments, the communication occurs without a user tapping before each move. For example, in some embodiments, the communications are automatically triggered or automatically triggered periodically (e.g., every 5 seconds for 3 minutes) after an initial trigger by the user such as at the top of the run. In some embodiments, a mid-range implementation is used where a device initiates the communication and receives/transmits the user identification once the device (with the user) is in range of a camera (e.g., a 5 m-10 m diameter circular area from the device). In some embodiments, the videos are transmitted to the user device 504 in segments of a specified length, and in some embodiments, the videos are streamed to the user device 504. In some embodiments, the server 502 shares the videos with additional users (e.g., a user's contacts). In some embodiments, the user device 504 is able to be used to share the videos. In some embodiments, a search function is implemented for users to search for others' videos.

FIG. 6 illustrates exemplary streaming videos according to some embodiments. The streaming videos are able to be viewed by users. In some embodiments, the videos are specifically matched to a user or a user device and are only accessible by the matched user or user device. In some embodiments, the videos are accessible by a broader audience, such as displayed on a television in a lodge. In some embodiments, the videos are ranked in groupings (e.g., “best air,” “best trick”) and displayed to viewers. In some embodiments, the videos are displayed, and the viewers are able to submit rankings In some embodiments, friends (e.g., Facebook® friends or mobile contacts) are able to access each others' videos.

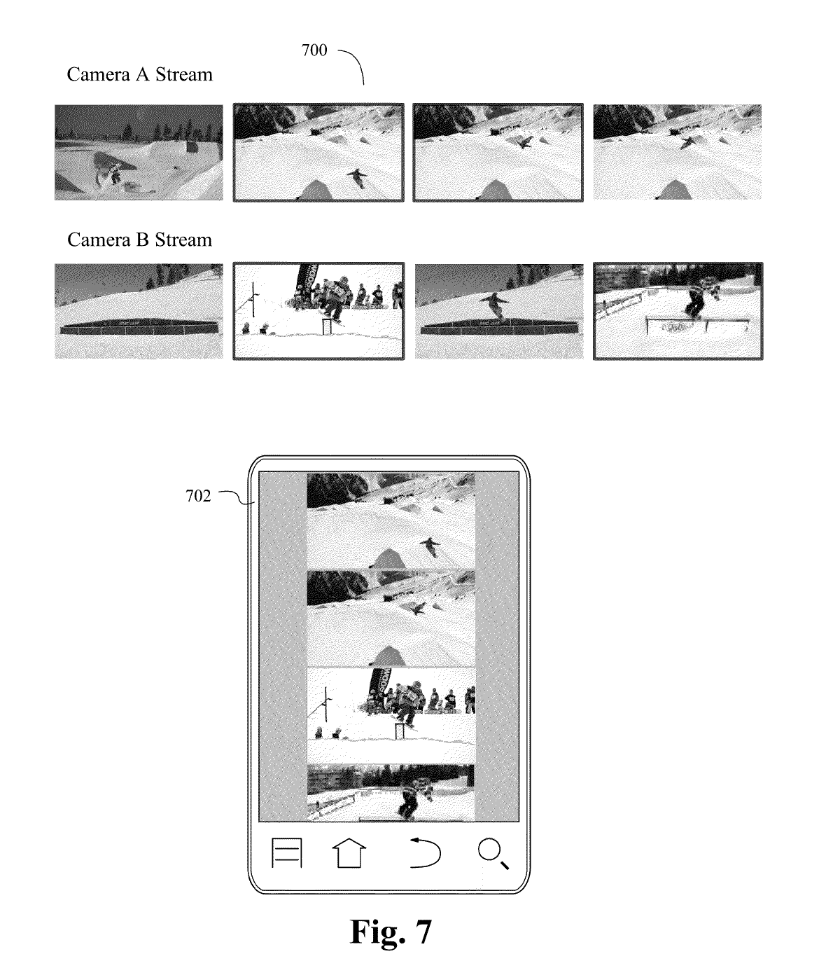

FIG. 7 illustrates a mobile device receiving selected clips from video streams according to some embodiments. The user is able to select clips 700 of a stream to download to a mobile device 702.

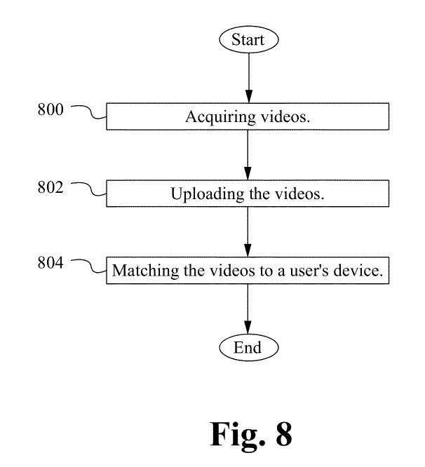

FIG. 8 illustrates a flowchart of a method of capturing videos and providing the videos to users according to some embodiments. In the step 800, one or more cameras acquire videos of a user as the user traverses a course. In the step 802, the acquired videos are automatically uploaded to a server. In the step 804, the videos are matched with a user's device and transmitted to the user's device. The videos are matched with the user's device using camera location data, NFC data, mid-range communication data, GPS data and/or timestamps in a smart phone or another device and/or any other information. In some embodiments, the videos are shared with other users. For example, the videos are automatically posted on a user's Facebook® page or on YouTube™. In some embodiments, fewer or additional steps are implemented. In some embodiments, the order of the steps is modified.

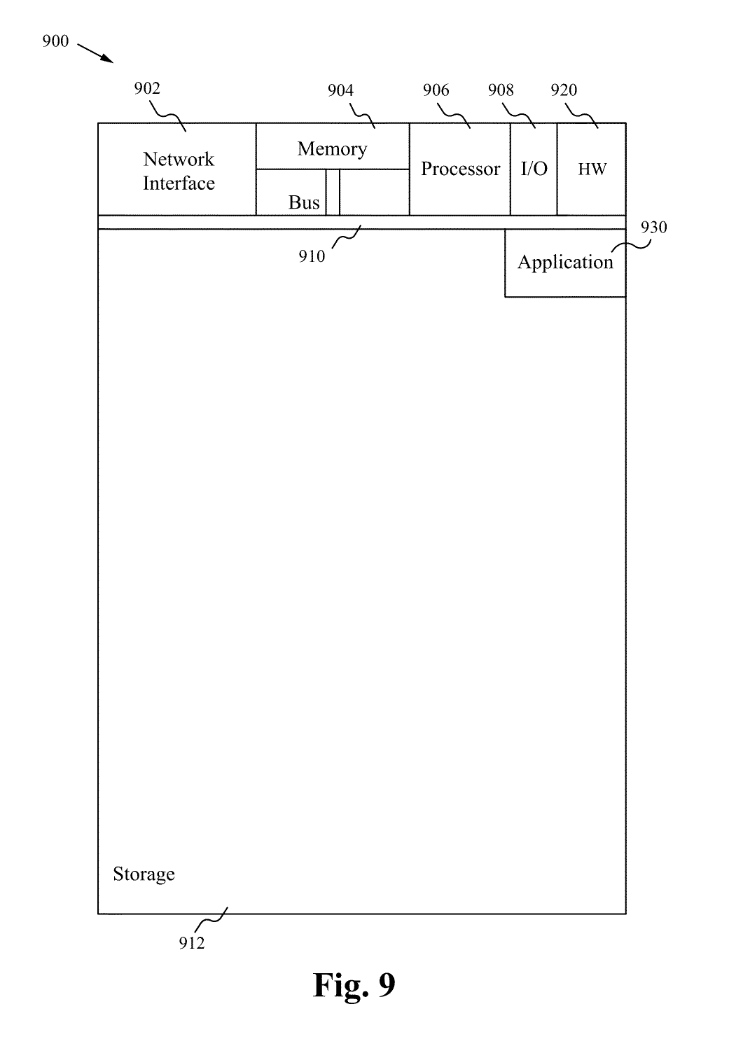

FIG. 9 illustrates a block diagram of an exemplary computing device configured to implement the sports experience method according to some embodiments. The computing device 900 is able to be used to acquire, store, compute, process, communicate and/or display information such as images and videos. For example, a computing device 900 is able to be used to acquire and transmit an image and/or video. In another example, the computing device 900 is able to receive an image and/or video, match the image and/or video with a user device and transmit the image and/or video to the user device. In another example, the computing device 900 is able to receive a matched image and/or video, display the image and/or video and/or share the image and/or video. In general, a hardware structure suitable for implementing the computing device 900 includes a network interface 902, a memory 904, a processor 906, I/O device(s) 908, a bus 910 and a storage device 912. The choice of processor is not critical as long as a suitable processor with sufficient speed is chosen. The memory 904 is able to be any conventional computer memory known in the art. The storage device 912 is able to include a hard drive, CDROM, CDRW, DVD, DVDRW, Blu-Ray®, flash memory card or any other storage device. The computing device 900 is able to include one or more network interfaces 902. An example of a network interface includes a network card connected to an Ethernet or other type of LAN. The I/O device(s) 908 are able to include one or more of the following: keyboard, mouse, monitor, display, printer, modem, touchscreen, button interface and other devices. In some embodiments, the hardware structure includes multiple processors and other hardware to perform parallel processing. Sports experience application(s) 930 used to perform the sports experience method are likely to be stored in the storage device 912 and memory 904 and processed as applications are typically processed. More or fewer components shown in FIG. 9 are able to be included in the computing device 900. In some embodiments, sports experience hardware 920 is included. Although the computing device 900 in FIG. 9 includes applications 930 and hardware 920 for implementing the sports experience method, the sports experience is able to be implemented on a computing device in hardware, firmware, software or any combination thereof. For example, in some embodiments, the sports experience applications 930 are programmed in a memory and executed using a processor. In another example, in some embodiments, the sports experience hardware 920 is programmed hardware logic including gates specifically designed to implement the method.

In some embodiments, the sports experience application(s) 930 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

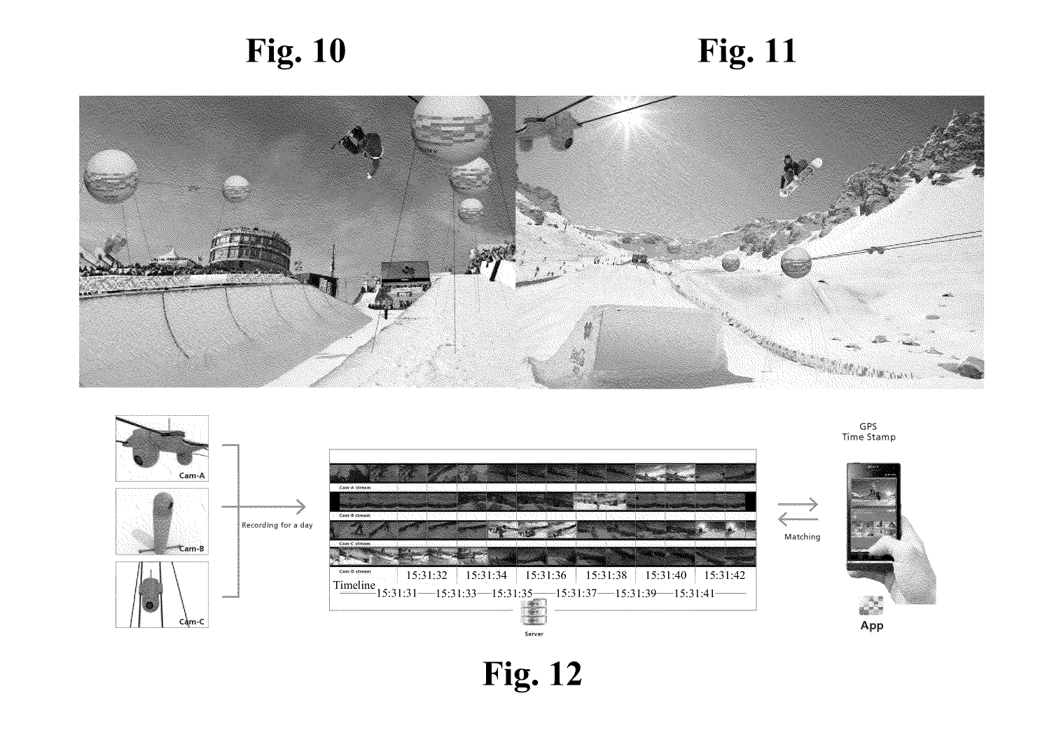

FIG. 10 illustrates an exemplary image of cable cameras coupled to wires coupled to balloons acquiring video and/or images of a snowboarder on a halfpipe according to some embodiments. FIG. 11 illustrates an exemplary image of cable cameras coupled to wires coupled to balloons acquiring video and/or images of a snowboarder on a run with jumps according to some embodiments.

FIG. 12 illustrates an exemplary system recording video and/or images using several different types of cameras, uploading the video streams to a server which matches the video and/or images to a user or a user's device according to some embodiments. The server is able to store and present the video streams in a manner enabling users to view a timeline of the video and/images.

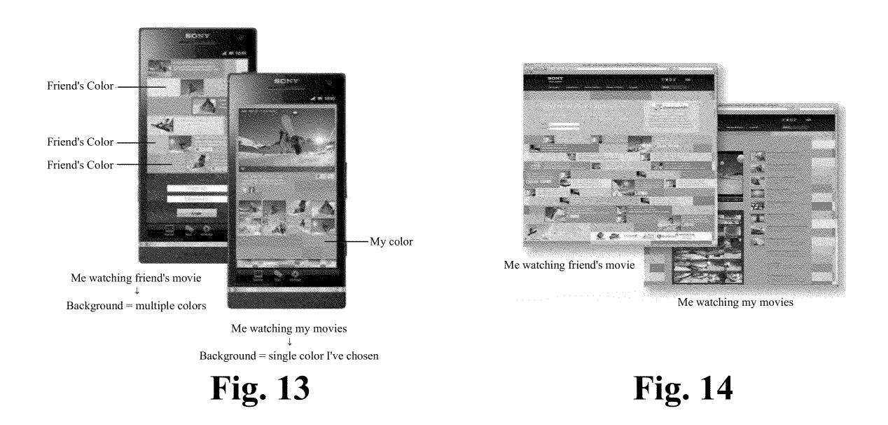

FIG. 13 illustrates a mobile device app with background colors reflecting each user's videos according to some embodiments. For example, a first friend's background is blue, a second friend's background is pink, and other friends have different colors or patterns. In some embodiments, when a user watches a friend's video, the background is multiple colors. In some embodiments, when a user watches his video, the background is a single color chosen by the user. The different colors help differentiate the videos from each other.

FIG. 14 illustrates a website with background colors reflecting each user's videos according to some embodiments. The differentiation is able to be the same as described herein regarding the mobile app.

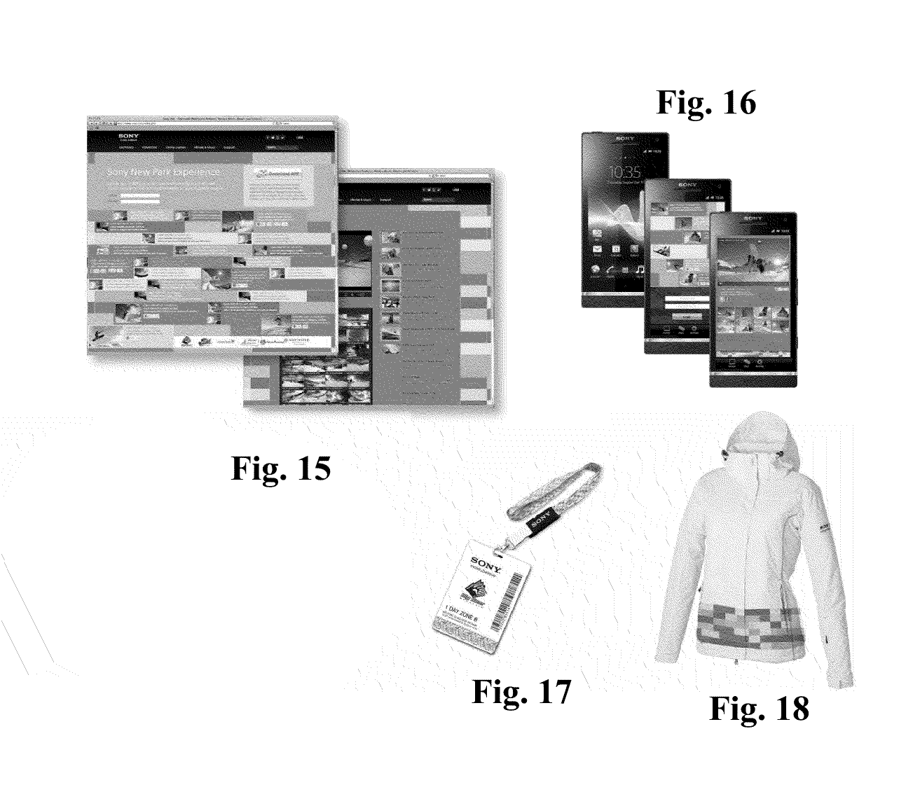

FIG. 15 illustrates an exemplary screenshot of browsers with content displayed related to the enhanced user experience according to some embodiments. FIG. 16 illustrates an exemplary screenshot of mobile devices with content displayed related to the enhanced user experience according to some embodiments.

FIG. 17 illustrates a lift ticket capable of implementing NFC or another communication implementation to match users with their videos and/or images according to some embodiments. FIG. 18 illustrates a jacket containing an embedded NFC chip or another communication device to match users with their videos and/or images according to some embodiments. Although a jacket is shown, any piece of clothing, backpack, equipment worn or coupled to the user is able to contain a communication device for matching users with their videos.

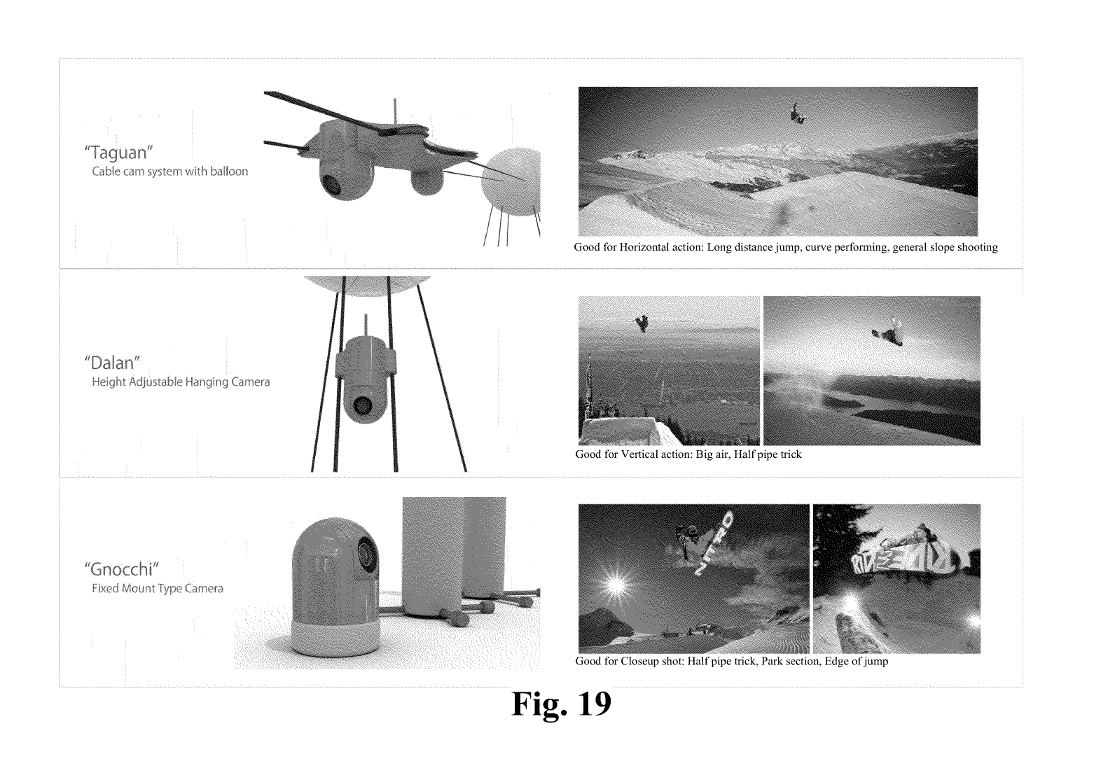

FIG. 19 illustrates three different types of cameras for enhancing a user experience and images acquired by the cameras according to some embodiments. A cable camera system includes a movable camera coupled to cables which are coupled to balloons. The cable camera system is able to move sideways. In some embodiments, the cable camera system includes one camera, two cameras or more cameras configured to acquire videos and/or images. The cable camera system is beneficial for acquiring horizontal action shots. A height adjustable hanging camera includes a camera coupled to vertical cables which are coupled to the ground and a balloon. The height adjustable hanging camera is able to move up and down on the cables. The height adjustable hanging camera is beneficial for vertical action shots. A fixed mount type camera includes a camera with a fixed base. The fixed mount type camera is able to be different heights. The fixed mount type camera is beneficial for closeup shots. Any of the camera implementations is able to be rotatable in any direction.

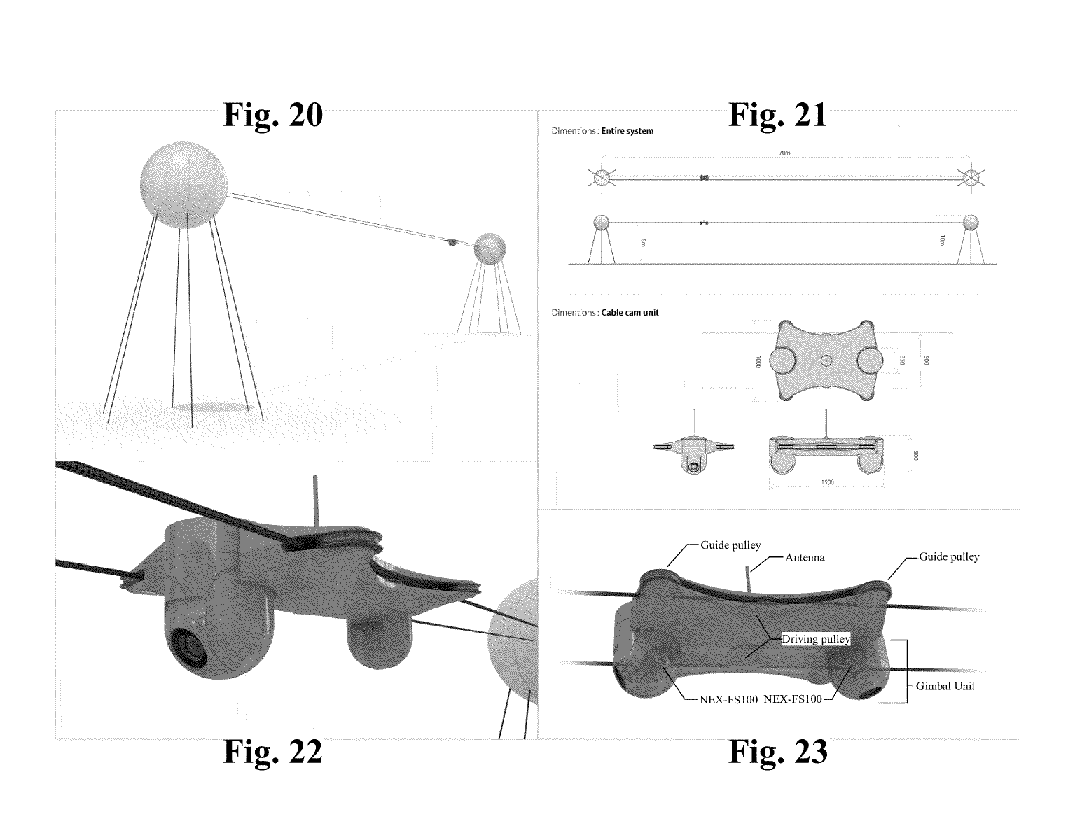

FIG. 20 illustrates a perspective view of a cable camera system with balloons according to some embodiments. FIG. 21 illustrates dimensions of the cable camera system with balloons according to some embodiments. FIG. 22 illustrates a closeup view of the cable camera system according to some embodiments. FIG. 23 illustrates components of a cable camera system according to some embodiments. The components include one or more guide pulleys for guiding the cable camera system, driving pulleys for pulling the cable camera system on the cables, a gimbal unit, an antenna for communication with a server, a user device and/or other devices and cameras for acquiring videos and/or images.

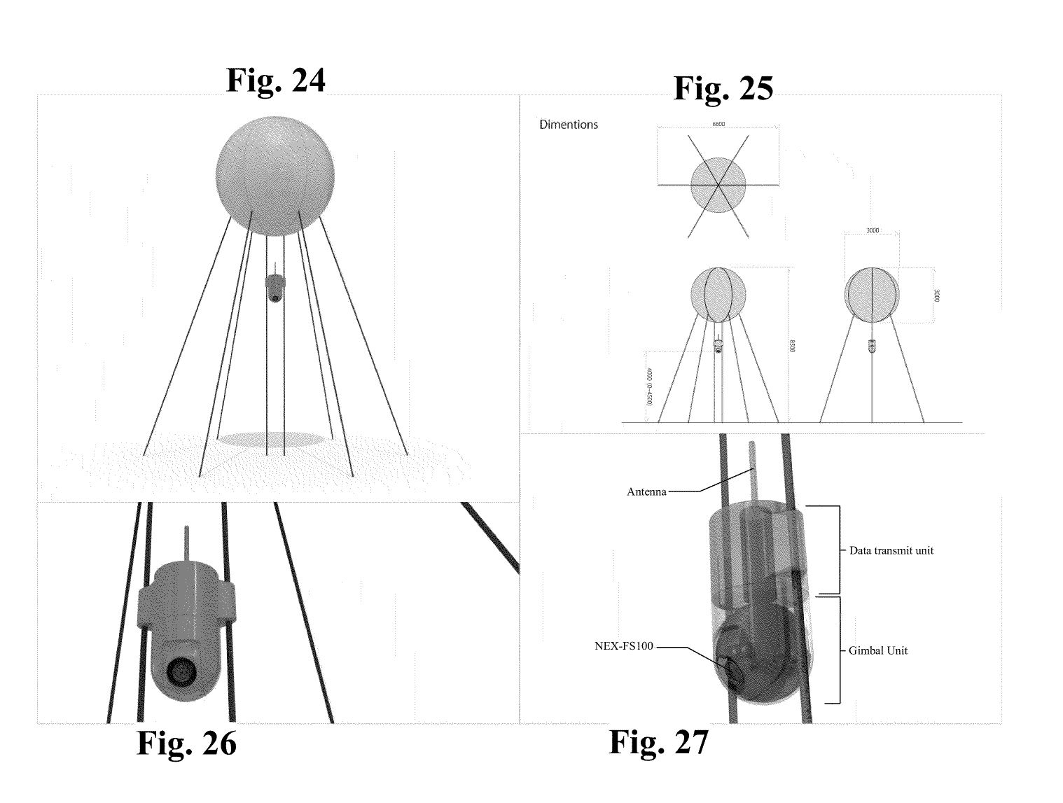

FIG. 24 illustrates a perspective view of a height adjustable hanging camera according to some embodiments. In some embodiments, the camera is able to move up and down the cables, and in some embodiments, the cable is fixed in position and the camera moves by raising or lowering the balloon. FIG. 25 illustrates dimensions of the height adjustable hanging camera according to some embodiments. FIG. 26 illustrates a closeup view of the height adjustable hanging camera according to some embodiments. FIG. 27 illustrates components of the height adjustable hanging camera according to some embodiments. The height adjustable hanging camera includes a data transmit unit for transmitting data, a gimbal unit, an antenna for communication with a server, a user device and/or other devices and cameras for acquiring videos and/or images.

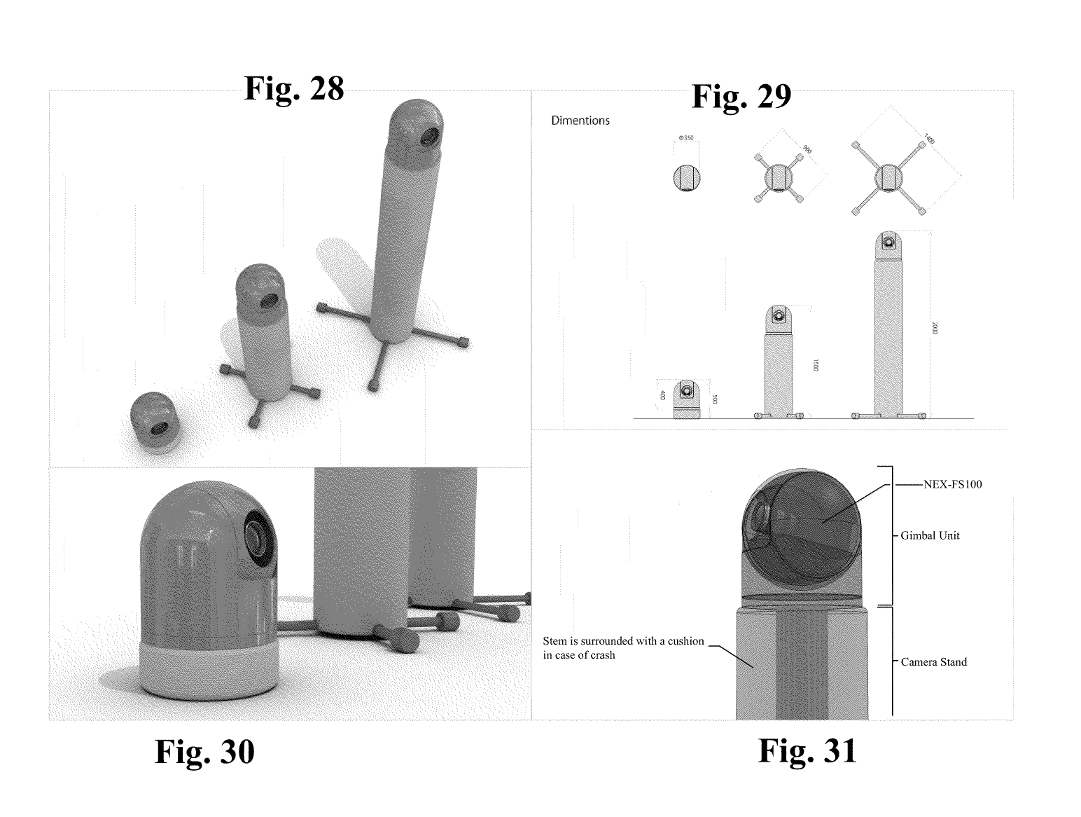

FIG. 28 illustrates a perspective view of fixed mount cameras according to some embodiments. The fixed mount cameras are a fixed height. The fixed mount cameras are able to be fixed at different heights such as short, medium and tall to capture different perspectives. FIG. 29 illustrates dimensions of the fixed mount cameras according to some embodiments. FIG. 30 illustrates a closeup view of a fixed mount camera according to some embodiments. FIG. 31 illustrates components of a fixed mount camera according to some embodiments. The fixed mount camera includes a camera stand, a gimbal unit and a camera for acquiring videos and/or images.

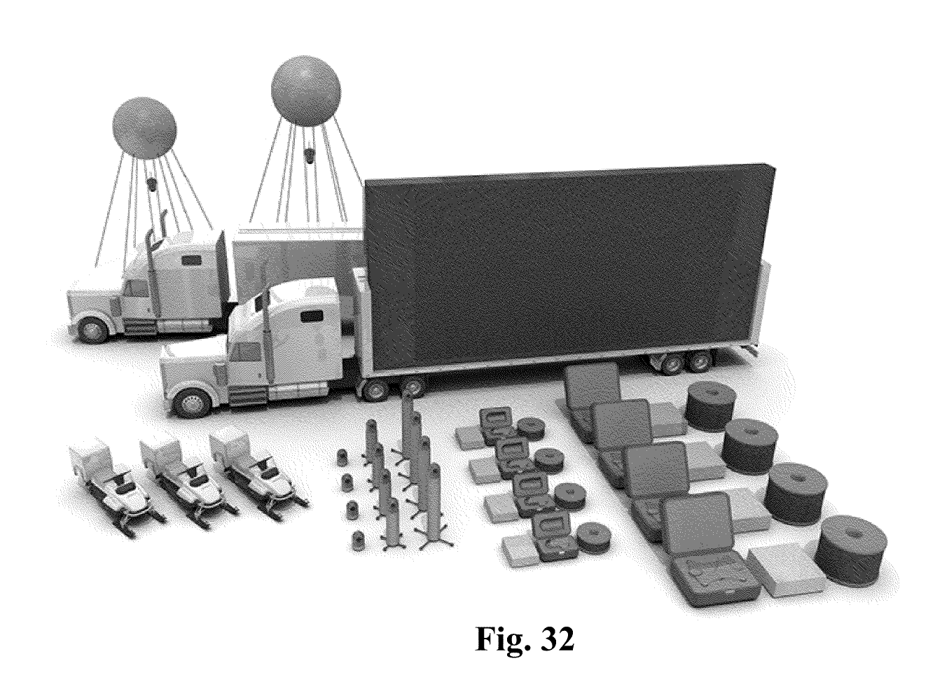

FIG. 32 illustrates a view of a total system for enhancing a user experience according to some embodiments. The total system is able to include: a large screen television, cable camera systems, height adjustable hanging cameras with a balloon, fixed mount cameras of varying sizes and any accompanying equipment.

In some embodiments, a method of dynamically advertising based on the user metadata contained in an NFC card, smart phone and/or other device is implemented. The dynamic advertising is able to be implemented by another device such as a television receiving the NFC data and presenting an advertisement specifically directed at the identified user. For example, the advertisement is able to use the identified user's name or present advertisements related to a user's personal information identified by the NFC card.

To utilize the sports experience, a user performs an activity (e.g., snowboarding), and the system automatically acquires video and images of the performance. In some embodiments, the user initiates an app before performing the activity, and in some embodiments, the sports experience is implemented without the user initiating an app. The user is able to receive the acquired video and images on a device such as a smart phone or other computing device, and the user is able to share the video and image. The sports experience is able to be implemented automatically without user involvement.

In operation, the sports experience provides users with captured videos with professional video quality from many different angles of the user's activity. The sports experience utilizes the user's mobile device to match the captured videos with the user, so that the user is able to conveniently receive the videos.

### Some Embodiments of Enhancing a User Experience Utilizing Camera Location Information and User Device Information

1. A method of providing an enhanced user experience programmed in a non-transitory memory of a device comprising:

a. receiving acquired content; and

b. transmitting the acquired content to a user device by matching the acquired content with the user device.

2. The method of clause 1 wherein the user experience is at a snow park, a skateboarding park, a BMX bike park, an amusement park, a racecar driving track or on a rafting trip in a river.
3. The method of clause 1 wherein the acquired content comprises a video and/or an image.
4. The method of clause 1 wherein the acquired content is acquired by a plurality of cameras positioned at a snow park to capture a user's experience from different angles and locations.
5. The method of clause 4 wherein the plurality of cameras includes at least one of a cable camera system with a balloon, a height adjustable hanging camera and a fixed mount camera.
6. The method of clause 1 wherein the acquired content is matched with the user device using location information of a camera and user information.
7. The method of clause 6 wherein the user information comprises GPS information of the user device and timestamp information of the user device.
8. The method of clause 6 wherein the user information comprises Near Field Communication information.
9. The method of clause 6 wherein the user information comprises mid-range communication information.
10. The method of clause 8 wherein the Near Field Communication information is stored in a lift ticket.
11. The method of clause 8 wherein the Near Field Communication information is stored in an article of clothing or equipment.
12. The method of clause 1 wherein the acquired content transmitted to the user device is a low resolution content, and a corresponding high resolution content is available for purchase.
13. The method of clause 1 further comprising sharing the acquired content with additional users by posting the content to a webpage or sending the content to phones of the additional users.
14. The method of clause 1 wherein the acquired content is displayed on the user device with a user-specific background.
15. The method of clause 1 further comprising presenting an advertisement on the user device using metadata contained in a user's Near Field Communication card or smart phone.
16. The method of clause 1 wherein the user device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
17. A method of receiving an enhanced user experience programmed in a non-transitory memory of a device comprising:

a. selecting content to receive; and

b. receiving the content from a server wherein the content is matched to the user device using camera location information and user device information.

18. The method of clause 17 wherein the user device information comprises one or more of GPS information, timestamp information, Near Field Communication information and mid-range communication information.
19. The method of clause 17 wherein the user experience is at a snow park, a skateboarding park, a BMX bike park, an amusement park, a racecar driving track or on a rafting trip in a river.
20. The method of clause 17 wherein the content comprises a video and/or an image.
21. The method of clause 17 wherein the content is acquired by a plurality of cameras positioned at a snow park to capture a user's experience from different angles and locations.
22. The method of clause 21 wherein the plurality of cameras includes at least one of a cable camera system with a balloon, a height adjustable hanging camera and a fixed mount camera.
23. The method of clause 17 wherein the content received is a low resolution content, and a corresponding high resolution content is available for purchase.
24. The method of clause 17 further comprising sharing the content with additional users by posting the content to a webpage or sending the content to phones of the additional users.
25. The method of clause 17 further comprising presenting an advertisement on the user device using metadata contained in a user's Near Field Communication card or smart phone.
26. The method of clause 17 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
27. A network of devices for providing an enhanced user experience comprising:

a. one or more cameras for acquiring content; and

b. a server for receiving the content and transmitting the content to a user device by matching the content with the user device using camera location information and user device information.

28. The network of devices of clause 27 wherein the user device information comprises one or more of GPS information, timestamp information, Near Field Communication information and mid-range communication information.
29. The network of devices of clause 27 wherein the user experience is at a snow park, a skateboarding park, a BMX bike park, an amusement park, a racecar driving track or on a rafting trip in a river.
30. The network of devices of clause 27 wherein the content comprises a video and/or an image.
31. The network of devices of clause 27 wherein the one or more cameras are positioned at a snow park.
32. The network of devices of clause 27 wherein the content received is a low resolution content, and a corresponding high resolution content is available for purchase.
33. The network of devices of clause 27 wherein the server is further for sharing the content with additional users.
34. The network of devices of clause 27 wherein the one or more cameras include at least one of a cable camera system with a balloon, a height adjustable hanging camera and a fixed mount camera.
35. A device comprising:

a. a memory for storing an application, the application for:
i. tracking locations of the device over a period of time;
ii. communicating the locations of the device with a server; and
iii. receiving content from the server, wherein the content is matched to the device using camera location information, the locations of the device and timestamp information; and

b. a processing component coupled to the memory, the processing component configured for processing the application.

36. The device of clause 35 wherein the content comprises a video and/or an image.
37. The device of clause 35 wherein the content is acquired by a plurality of cameras positioned at a snow park to capture a user's experience from different angles and locations.
38. The device of clause 37 wherein the plurality of cameras includes at least one of a cable camera system with a balloon, a height adjustable hanging camera and a fixed mount camera.
39. The device of clause 35 wherein the content is a low resolution content, and a corresponding high resolution content is available for purchase.
40. The device of clause 35 wherein the application is further for sharing the content with additional users by posting the content to a webpage or sending the content to phones of the additional users.
41. The device of clause 35 wherein the application displays the content on the device with a user-specific background.
42. The device of clause 35 wherein the application is further for presenting an advertisement on the device using metadata contained in a user's Near Field Communication card or smart phone.
43. A server device comprising:

a. a memory for storing an application, the application for:
i. receiving content acquired by a plurality of cameras including camera location information;
ii. receiving user device information from a tracked user device; and
iii. transmitting the content to the tracked user device by matching the acquired content with the tracked user device using the camera location information and the user device information; and

b. a processing component coupled to the memory, the processing component configured for processing the application.

44. The server device of clause 43 wherein the user device information comprises one or more of GPS information, timestamp information, Near Field Communication information and mid-range communication information.
45. The server device of clause 43 wherein the acquired content comprises a video and/or an image.
46. The server device of clause 43 wherein the plurality of cameras are positioned at the snow park to capture a user's experience from different angles and locations.
47. The server device of clause 43 wherein the content transmitted to the user device are low resolution content, and corresponding high resolution content are available for purchase.
48. The server device of clause 43 wherein the application is further for sharing the content with additional users by posting the content to a webpage or sending the content to phones of the additional users.
49. The server device of clause 43 wherein the plurality of cameras includes at least one of a cable camera system with a balloon, a height adjustable hanging camera and a fixed mount camera.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of providing an enhanced user experience programmed in a non-transitory memory of a device comprising:
a. receiving acquired content; and
b. transmitting the acquired content to a user device by matching the acquired content with the user device.

2. The method of claim 1 wherein the user experience is at a snow park, a skateboarding park, a BMX bike park, an amusement park, a racecar driving track or on a rafting trip in a river.

3. The method of claim 1 wherein the acquired content comprises a video and/or an image.

4. The method of claim 1 wherein the acquired content is acquired by a plurality of cameras positioned at a snow park to capture a user's experience from different angles and locations.

5. The method of claim 4 wherein the plurality of cameras includes at least one of a cable camera system with a balloon, a height adjustable hanging camera and a fixed mount camera.

6. The method of claim 1 wherein the acquired content is matched with the user device using location information of a camera and user information.

7. The method of claim 6 wherein the user information comprises GPS information of the user device and timestamp information of the user device.

8. The method of claim 6 wherein the user information comprises Near Field Communication information.

9. The method of claim 6 wherein the user information comprises mid-range communication information.

10. The method of claim 8 wherein the Near Field Communication information is stored in a lift ticket.

11. The method of claim 8 wherein the Near Field Communication information is stored in an article of clothing or equipment.

12. The method of claim 1 wherein the acquired content transmitted to the user device is a low resolution content, and a corresponding high resolution content is available for purchase.

13. The method of claim 1 further comprising sharing the acquired content with additional users by posting the content to a webpage or sending the content to phones of the additional users.

14. The method of claim 1 wherein the acquired content is displayed on the user device with a user-specific background.

15. The method of claim 1 further comprising presenting an advertisement on the user device using metadata contained in a user's Near Field Communication card or smart phone.

16. The method of claim 1 wherein the user device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

17. A method of receiving an enhanced user experience programmed in a non-transitory memory of a device comprising:
a. selecting content to receive; and
b. receiving the content from a server wherein the content is matched to the user device using camera location information and user device information.

18. The method of claim 17 wherein the user device information comprises one or more of GPS information, timestamp information, Near Field Communication information and mid-range communication information.

19. The method of claim 17 wherein the user experience is at a snow park, a skateboarding park, a BMX bike park, an amusement park, a racecar driving track or on a rafting trip in a river.

20. The method of claim 17 wherein the content comprises a video and/or an image.

21. The method of claim 17 wherein the content is acquired by a plurality of cameras positioned at a snow park to capture a user's experience from different angles and locations.

22. The method of claim 21 wherein the plurality of cameras includes at least one of a cable camera system with a balloon, a height adjustable hanging camera and a fixed mount camera.

23. The method of claim 17 wherein the content received is a low resolution content, and a corresponding high resolution content is available for purchase.

24. The method of claim 17 further comprising sharing the content with additional users by posting the content to a webpage or sending the content to phones of the additional users.

25. The method of claim 17 further comprising presenting an advertisement on the user device using metadata contained in a user's Near Field Communication card or smart phone.

26. The method of claim 17 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

27. A network of devices for providing an enhanced user experience comprising:
a. one or more cameras for acquiring content; and
b. a server for receiving the content and transmitting the content to a user device by matching the content with the user device using camera location information and user device information.

28. The network of devices of claim 27 wherein the user device information comprises one or more of GPS information, timestamp information, Near Field Communication information and mid-range communication information.

29. The network of devices of claim 27 wherein the user experience is at a snow park, a skateboarding park, a BMX bike park, an amusement park, a racecar driving track or on a rafting trip in a river.

30. The network of devices of claim 27 wherein the content comprises a video and/or an image.

31. The network of devices of claim 27 wherein the one or more cameras are positioned at a snow park.

32. The network of devices of claim 27 wherein the content received is a low resolution content, and a corresponding high resolution content is available for purchase.

33. The network of devices of claim 27 wherein the server is further for sharing the content with additional users.

34. The network of devices of claim 27 wherein the one or more cameras include at least one of a cable camera system with a balloon, a height adjustable hanging camera and a fixed mount camera.

35. A device comprising:
a. a memory for storing an application, the application for:
i. tracking locations of the device over a period of time;
ii. communicating the locations of the device with a server; and
iii. receiving content from the server, wherein the content is matched to the device using camera location information, the locations of the device and timestamp information; and
b. a processing component coupled to the memory, the processing component configured for processing the application.

36. The device of claim 35 wherein the content comprises a video and/or an image.

37. The device of claim 35 wherein the content is acquired by a plurality of cameras positioned at a snow park to capture a user's experience from different angles and locations.

38. The device of claim 37 wherein the plurality of cameras includes at least one of a cable camera system with a balloon, a height adjustable hanging camera and a fixed mount camera.

39. The device of claim 35 wherein the content is a low resolution content, and a corresponding high resolution content is available for purchase.

40. The device of claim 35 wherein the application is further for sharing the content with additional users by posting the content to a webpage or sending the content to phones of the additional users.

41. The device of claim 35 wherein the application displays the content on the device with a user-specific background.

42. The device of claim 35 wherein the application is further for presenting an advertisement on the device using metadata contained in a user's Near Field Communication card or smart phone.

43. A server device comprising:
a. a memory for storing an application, the application for:
i. receiving content acquired by a plurality of cameras including camera location information;
ii. receiving user device information from a tracked user device; and
iii. transmitting the content to the tracked user device by matching the acquired content with the tracked user device using the camera location information and the user device information; and
b. a processing component coupled to the memory, the processing component configured for processing the application.

44. The server device of claim 43 wherein the user device information comprises one or more of GPS information, timestamp information, Near Field Communication information and mid-range communication information.

45. The server device of claim 43 wherein the acquired content comprises a video and/or an image.

46. The server device of claim 43 wherein the plurality of cameras are positioned at the snow park to capture a user's experience from different angles and locations.

47. The server device of claim 43 wherein the content transmitted to the user device are low resolution content, and corresponding high resolution content are available for purchase.

48. The server device of claim 43 wherein the application is further for sharing the content with additional users by posting the content to a webpage or sending the content to phones of the additional users.

49. The server device of claim 43 wherein the plurality of cameras includes at least one of a cable camera system with a balloon, a height adjustable hanging camera and a fixed mount camera.
